(19) United States
(12) Patent Application Publication
(10) Pub. No.: US 2007/0252432 A1
(43) Pub. Date: Nov. 1, 2007

(54) Control device for vehicle, and control method therefor

(75) Inventor: Hideki Takamatsu, Susono-shi (JP)

Correspondence Address: SUGHRUE MION, PLLC, 2100 PENNSYLVANIA AVENUE, N.W., SUITE 800, WASHINGTON, DC, 20037, US

(73) Assignee: Toyota Jidosha Kabushiki Kaisha, Toyota-shi (JP)

(21) Appl. No.: 11/706,180

(22) Filed: Feb. 15, 2007

(30) Foreign Application Priority Data
Apr. 28, 2006 (JP) 2006-126218

(51) Int. Cl. B60T 8/32

(52) U.S. Cl. 303/167

(57) ABSTRACT

An ECU executes a program that includes the steps of: setting a target deceleration of an operation vehicle on the basis of the operation amount of a brake pedal; controlling a brake device so that the deceleration caused by the braking force from the brake device becomes equal to a target deceleration; controlling a belt type stepless transmission to achieve a gear ratio where the braking force from the powertrain, that is, the deceleration caused by engine braking, becomes equal to the target deceleration, if a shift lever is operated so as to shift the belt type stepless transmission downward; and controlling the brake device so that the deceleration caused by the brake device gradually increases.

### INCORPORATION BY REFERENCE

The disclosure of Japanese Patent Application No. 2006-126218 filed on Apr. 28, 2006 including the specification, drawings and abstract is incorporated herein by reference in its entirety.

### BACKGROUND OF THE INVENTION

1. Field of the Invention

The invention relates to a control device for a vehicle, and a control method therefor. More particularly, the invention relates to a technology of decelerating a vehicle via a powertrain and a braking mechanism that restrains the rotation of wheels by friction.

2. Description of the Related Art

To decelerate a vehicle, a foot brake that restrains the rotation of wheels by friction is used. The foot brake generates braking force that is in accordance with the amount of operation of the brake pedal. When the foot brake is actuated to decelerate the vehicle, the vehicle's behavior changes. For example, if the braking forces on the wheels are not equal, the vehicle may spin. Therefore, there is proposed a technology of adjusting the braking force by taking into account the state of the vehicle in addition to the operation amount of the brake pedal.

Japanese Patent Application Publication No. JP-A-10-264791 describes a vehicular braking force control device capable of obtaining braking that is optimal to the operation condition of the vehicle and the vehicle ambient environment. The described vehicular braking force control device includes: a brake pedal depression amount detection portion that detects the depression amount of a brake pedal; a target braking force generation portion that generates a target braking force from the depression amount of the brake pedal; a prime mover operating point detection portion that finds the operating point of the prime mover; a gear ratio detection portion that detects the gear ratio of a transmission; a prime mover minus torque-derived braking force calculation portion that calculates the braking force on the driving wheels that is caused by the minus torque of the prime mover; a braking force share ratio determination portion that determines the proportions of the share braking forces to be borne by the driving wheels and the non-driving wheels from the operation condition of the vehicle; a braking command value generation portion that finds a braking command value for the driving wheels and a braking command value for the non-driving wheels from the target braking force, the braking force share ratio, and the prime mover minus torque-derived braking force; and brake actuators that cause the wheels to generate braking forces in accordance with the braking command values.

According to the vehicular braking force control device described in this publication, the braking by the brake actuators is performed when the brake pedal is depressed. When the operating point of the prime mover shifts into the minus torque side, the braking of the driving wheels by the minus torque is performed. On the basis of the depression amount of the brake pedal, and the braking force of the driving wheels by the minus torque of the prime mover as well as the braking force share ratio between the driving wheels and the non-driving wheels determined from the operation condition of the vehicle, a control command value of the driving wheels and a control command value of the non-driving wheels are found, and the corresponding brake actuators are actuated. Due to this, an appropriate braking force share ratio can be obtained with respect to changes in the operation condition of the vehicle such as the road slope, the vehicle weight distribution, etc. Therefore, all the wheels can generate braking force with the same slip rate. As a result, the vehicle can be decelerated and stopped in a stable and optimal state.

When the driver decelerates the vehicle, the driver may sometimes downshift the transmission in addition to operating the brake pedal. The downshift increases the braking force generated through engine braking. In this case, the braking force contributed by the downshift depends on the amount of change of the gear ratio. Therefore, when a downshift is performed, it can sometimes happen that a braking force that is greater than the driver expects is generated or the braking force is insufficient despite the the downshift. However, this problem is not considered at all in Japanese Patent Application Publication No. JP-A-10-264791.

### SUMMARY OF THE INVENTION

The invention provides a control device for a vehicle that decelerates the vehicle in precise accordance with the driver's need by taking into account the braking force that is obtained by downshift.

A control device in accordance with a first aspect of the invention controls a vehicle that includes a braking mechanism that restrains rotation of a wheel by using friction force; and a powertrain that transmits drive force from a power source to the wheel via a transmission. The control device includes: a setting device for setting a physical amount that represents a rate of deceleration of the vehicle, in accordance with an operation of a driver performed on a first operating member; first control portion for controlling the braking mechanism so that the rate of deceleration of the vehicle caused by braking force from the braking mechanism becomes substantially equal to the rate of deceleration that corresponds to the set physical amount; a calculation device for calculating an appropriate gear ratio where the rate of deceleration of the vehicle caused by the braking force from the powertrain becomes substantially equal to the rate of deceleration that corresponds to the set physical amount; second control portion for controlling the transmission to achieve the calculated gear ratio if the second operating member is operated by the driver during the deceleration of the vehicle caused by the braking mechanism; and third control portion for controlling the braking mechanism to decrease the braking force caused by the braking mechanism if the braking force from the powertrain is increased by controlling the transmission during execution of the second control.

According to this aspect, the physical amount that represents the rate of deceleration of the vehicle is set in accordance with the operation of the driver performed on the first operating member. The braking mechanism is controlled so that the rate of deceleration of the vehicle caused by the braking force from the braking mechanism becomes substantially equal to the rate of deceleration that corresponds to the set physical amount. Therefore, the vehicle can be decelerated at the rate of deceleration that is in accordance with the driver's operation. If during this state, the driver operates the second operating member, the transmission is controlled to achieve a gear ratio where the rate of deceleration of the vehicle caused by the braking force from the powertrain becomes substantially equal to the rate of deceleration that corresponds to the set physical amount. If the braking force from the powertrain increases due to a change in the gear ratio, the braking mechanism is controlled to decrease the braking force caused by the braking mechanism. Therefore, the gear ratio can be changed so that the vehicle is decelerated at the rate of deceleration that is in accordance with the driver's operation. Hence, it is possible to provide a control device for a vehicle that decelerates the vehicle in precise accordance with the driver's need.

The automatic transmission may be a stepless transmission.

Thus, the use of the stepless transmission that steplessly adjusts the gear ratio makes it possible to accurately adjust the rate of deceleration of the vehicle by the powertrain.

A second aspect of the invention relates to a control method for a vehicle which includes:

setting a physical amount that represents a rate of deceleration of the vehicle, in accordance with an operation of a driver performed on a first operating member;

performing a first control on braking mechanism for restraining rotation of a wheel by using friction force so that the rate of deceleration of the vehicle caused by braking force from the braking mechanism becomes substantially equal to the rate of deceleration that corresponds to the set physical amount;

calculating such a gear ratio that the rate of deceleration of the vehicle caused by the braking force from a powertrain that transmits drive force from a power source to the wheel via a transmission becomes substantially equal to the rate of deceleration that corresponds to the set physical amount;

performing a second control on the transmission to achieve the calculated gear ratio if the second operating member is operated by the driver during the deceleration of the vehicle caused by the braking mechanism; and

performing a third control on the braking mechanism to decrease the braking force caused by the braking mechanism if the braking force from the powertrain is increased by controlling the transmission through the second control.

The first operating member may be a brake pedal, and the second operating member may be a shift lever.

According to the second aspect of the invention, the gear ratio may be changed so that the vehicle decelerates at a rate of deceleration that is in accordance with the driver's operation. Therefore, it is possible to provide a control method for a vehicle that decelerates the vehicle in precise accordance with the driver's need.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a skeleton diagram of a vehicle equipped with a control device in accordance with an embodiment of the invention;

FIG. 2 is a control block diagram showing the control device in accordance with the embodiment of the invention;

FIG. 3 is a diagram showing a part of hydraulic control circuit that is controlled by the control device in accordance with the embodiment of the invention;

FIG. 4 is a diagram showing a part of the hydraulic control circuit that is controlled by the control device in accordance with the embodiment of the invention;

FIG. 5 is a diagram showing a part of the hydraulic control circuit that is controlled by the control device in accordance with the embodiment of the invention;

FIG. 6 is a control block diagram showing an ECU shown in FIG. 2;

FIG. 7 is a flowchart showing a control structure of a program executed by the ECU of the control device in accordance with the embodiment of the invention;

FIG. 8 is a diagram showing the deceleration caused by a brake device, and the deceleration caused by a powertrain; and

FIG. 9 is a diagram showing the deceleration caused by the brake device.

### DETAILED DESCRIPTION OF THE PREFERRED EMBODIMENTS

Embodiments of the invention will be described hereinafter with reference to the drawings. In the following description, the same component parts are affixed with the same reference characters. The names and functions of those component parts are also the same. Therefore, detailed descriptions thereof will not be repeated.

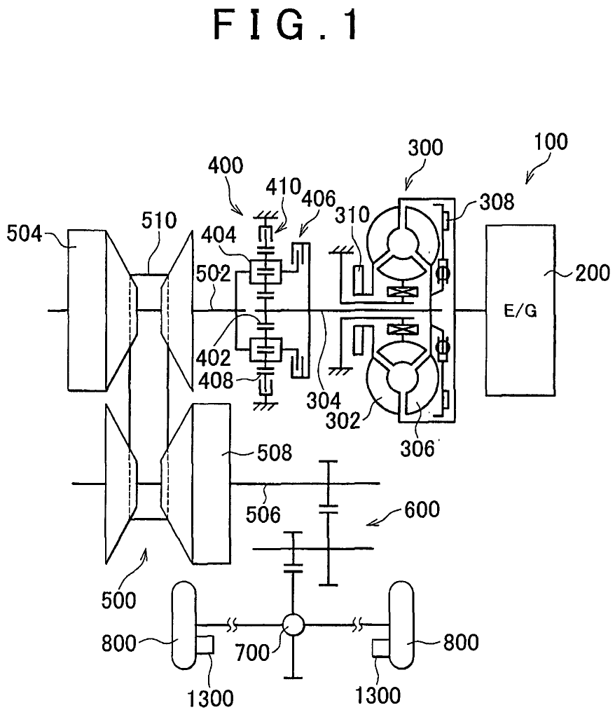

With reference to FIG. 1, a vehicle in which a control device in accordance with an embodiment of the invention is mounted will be described. Output of an engine 200 of a powertrain 100 mounted in this vehicle is input to a belt type stepless transmission 500 via a torque converter 300 and a forward-reverse travel switch device 400. The output of the belt type stepless transmission 500 is transmitted to a reduction gear 600 and a differential gear device 700, and is thereby distributed to left and right driving wheels 800. The rotation of the driving wheels 800 is restrained by brake devices 1300. Each brake device 1300 restrains the rotation of a corresponding one of the driving wheels 800 by friction force.

The powertrain 100 is controlled by an ECU (Electronic Control Unit) 900 described later. The control in accordance with the embodiment is realized by, for example, a program that is executed by the ECU 900. Incidentally, instead of the belt type stepless transmission 500, a different transmission, such as a toroidal type stepless transmission or the like, may be used.

The torque converter 300 is constructed of a pump impeller 302 linked to the crankshaft of the engine 200, and a turbine impeller 306 linked to the forward-reverse travel switch device 400 via a turbine shaft 304. A lockup clutch 308 is provided between the pump impeller 302 and the turbine impeller 306. The lockup clutch 308 may be engaged or released by switching the oil pressure supply between an engagement oil chamber and a release oil chamber.

By completely engaging the lockup clutch 308, the pump impeller 302 and the turbine impeller 306 are integrally rotated together. The pump impeller 302 is provided with a mechanical oil pump 310 that generates oil pressures for controlling the shift of the belt type stepless transmission 500, and generating a belt clamping pressure, and supplying lubricating oil to various portions.

The forward-reverse travel switch device 400 is constructed of a double-pinion type planetary gear device. The turbine shaft 304 of the torque converter 300 is linked to a sun gear 402. An input shaft 502 of the belt type stepless transmission 500 is linked to a carrier 404. The carrier 404 and the sun gear 402 are linked via a forward clutch 406. A ring gear 408 is fixed to a housing via a reverse brake 410. Each of the forward clutch 406 and the reverse brake 410 is put into friction engagement by a hydraulic cylinder. The input rotation speed of the forward clutch 406 is the same as the rotation speed of the turbine shaft 304, that is, the turbine rotation speed NT.

When the forward clutch 406 is engaged and the reverse brake 410 is released, the forward-reverse travel switch device 400 assumes a forward-travel engaged state. In this state, drive force in the forward travel direction is transmitted to the belt type stepless transmission 500. When the reverse brake 410 is engaged and the forward clutch 406 is released, the forward-reverse travel switch device 400 assumes a reverse-travel engaged state. In this state, the input shaft 502 is rotated in a direction opposite to the rotation direction of the turbine shaft 304. Due to this, drive force in the reverse travel direction is transmitted to the belt type stepless transmission 500. When the forward clutch 406 and the reverse brake 410 are both released, the forward-reverse travel switch device 400 assumes a neutral state in which the power transmission is shut off. 100231 The belt type stepless transmission 500 is constructed of a primary pulley 504 provided on the input shaft 502, a secondary pulley 508 provided on an output shaft 506, and a transmission belt 510 mounted on the pulleys. Using the friction forces between the transmission belt 510 and the pulleys, the power transmission is performed.

Each pulley is constructed of a hydraulic cylinder so that the groove width thereof is variable. By controlling the oil pressure of the hydraulic cylinder of the primary pulley 504, the groove width of each pulley is changed. In this manner, the pulley contact diameters of the transmission belt 510 are altered, and the gear ratio GR (=primary pulley rotation speed NIN/secondary pulley rotation speed NOUT) is continuously changed.

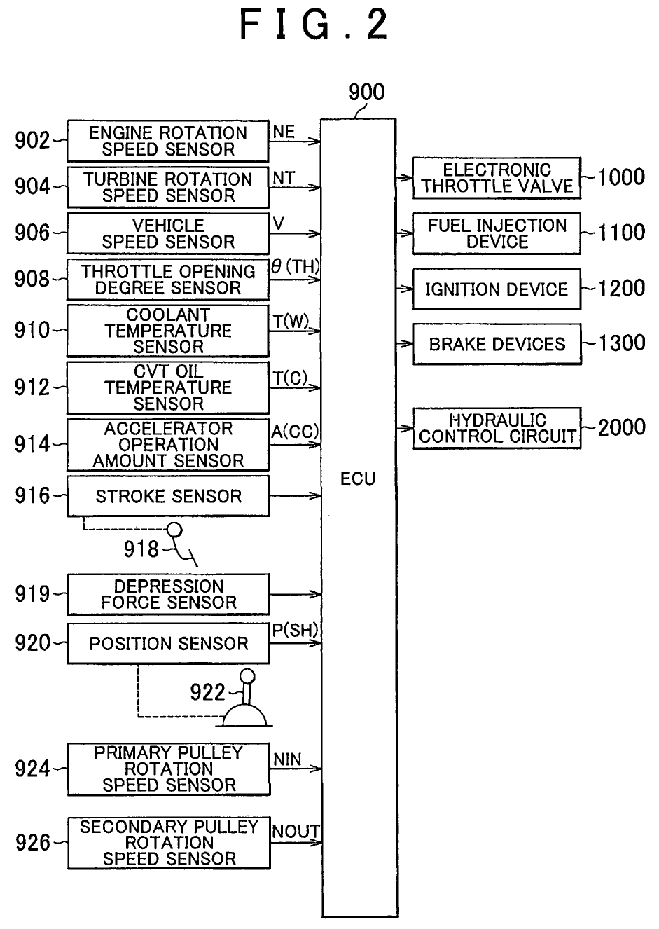

As shown in FIG. 2, various sensors are connected to the ECU 900, including an engine rotation speed sensor 902, a turbine rotation speed sensor 904, a vehicle speed sensor 906, a throttle opening degree sensor 908, a coolant temperature sensor 910, an oil temperature sensor 912, an accelerator operation amount sensor 914, a stroke sensor 916, a depression force sensor 919, a position sensor 920, a primary pulley rotation speed sensor 924, and a secondary pulley rotation speed sensor 926.

The engine rotation speed sensor 902 detects the rotation speed (engine rotation speed) NE of the engine 200. The turbine rotation speed sensor 904 detects the rotation speed (turbine rotation speed) NT of the turbine shaft 304. The vehicle speed sensor 906 detects the vehicle speed V. The throttle opening degree sensor 908 detects the degree of opening θ (TH) of an electronic throttle valve. The coolant temperature sensor 910 detects the coolant temperature T(W) of the engine 200. The oil temperature sensor 912 detects the oil temperature T(C) of the belt type stepless transmission 500 and the like. The accelerator operation amount sensor 914 detects the amount of depression A(CC) of an accelerator pedal. The stroke sensor 916 detects the amount of operation (amount of stroke) of a brake pedal 918. The depression force sensor 919 detects the depression force of the brake pedal 918 (the force with which a driver depresses the brake pedal 918). The position sensor 920 detects the position P(SH) of a shift lever 922 by discriminating whether a contact provided at a position corresponding to the shift position is on or off. The primary pulley rotation speed sensor 924 detects the rotation speed NIN of the primary pulley 504. The secondary pulley rotation speed sensor 926 detects the rotation speed NOUT of the secondary pulley 508. A signal of each of the sensors representing a result of detection is sent to the ECU 900. The turbine rotation speed NT during the forward movement of the vehicle with the forward clutch 406 engaged is equal to the primary pulley rotation speed NIN. The vehicle speed V assumes value that corresponds to the secondary pulley rotation speed NOUT. Therefore, when the vehicle is stopped and the forward clutch 406 is engaged, the turbine rotation speed NT is 0.

The ECU 900 includes a CPU (Central Processing Unit), a memory, an input/output interface, etc. The CPU performs signal processing in accordance with programs stored in the memory. In this manner, an output control of the engine 200, a shift control of the belt type stepless transmission 500, a belt clamping pressure control, an engagement/release control of the forward clutch 406, an engagement/release control of the reverse brake 410, etc. are executed.

The output control of the engine 200 is performed via an electronic throttle valve 1000, a fuel injection device 1100, an ignition device 1200, etc. The shift control of the belt type stepless transmission 500, the belt clamping pressure control, the engagement/release control of the forward clutch 406, and the engagement/release control of the reverse brake 410 are performed via a hydraulic control circuit 2000.

In this embodiment, the ECU 900 performs the shift control of the belt type stepless transmission 500 in either an automatic mode or a manual mode. The automatic mode refers to a control in which the shifting is automatically performed in accordance with the accelerator operation amount and the vehicle speed. The manual mode refers to a control in which the gear ratio is altered or a range in which the gear ratio is changeable is altered in accordance with the driver's operation of the shift lever 922. Incidentally, because the automatic mode and the manual mode can be realized by using a well-known common technology, detailed description thereof will not be repeated herein.

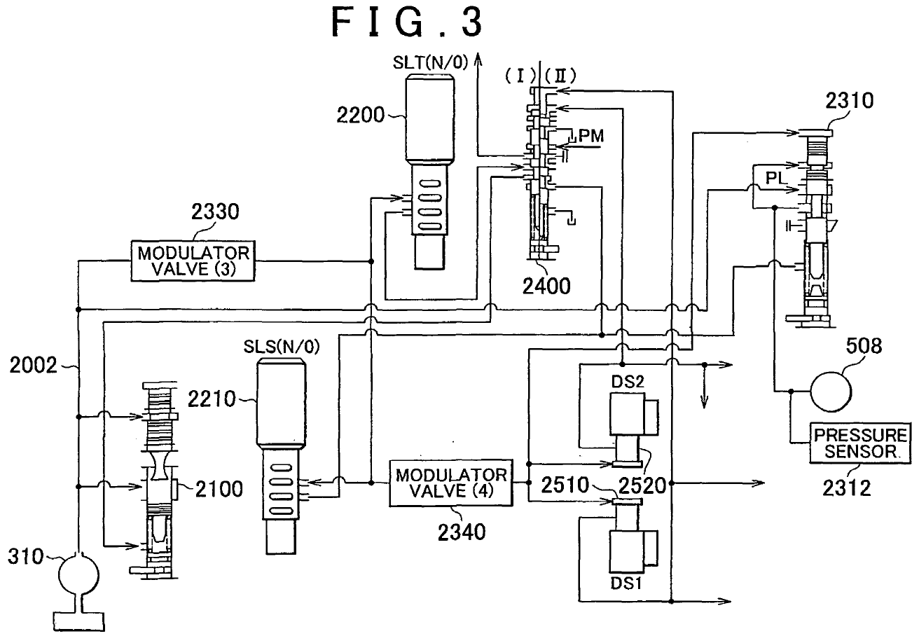

With reference to FIG. 3, a portion of the hydraulic control circuit 2000 will be described. The oil pressure generated by the oil pump 310 is supplied to a primary regulator valve 2100, a modulator valve (1) 2310, and a modulator valve (3) 2330 via a line pressure oil passageway 2002.

The primary regulator valve 2100 is supplied with a control pressure selectively from one of an SLT linear solenoid valve 2200 and an SLS linear solenoid valve 2210. In this embodiment, both the SLT linear solenoid valve 2206 and the SLS linear solenoid valve 2210 are normally-open solenoid valves (in which the output oil pressure becomes maximum when not electrified). Normally-closed solenoid valves may also be used as the SLT linear solenoid valve 2200 and the SLS linear solenoid valve 2210 (in which the output oil pressure becomes minimum (“0”) when not electrified).

A spool of the primary regulator valve 2100 slides up and down in accordance with the supplied control pressure. In this manner, the oil pressure generated by the oil pump 310 is regulated (adjusted) by the primary regulator valve 2100. The oil pressure regulated by the primary regulator valve 2100 is used as the line pressure PL. In this embodiment, increases in the control pressure supplied to the primary regulator valve 2100 also increase the line pressure PL. Alternatively, increases in the control pressure supplied to the primary regulator valve 2100 may instead reduce the line pressure PL.

The SLT linear solenoid valve 2200 and the SLS linear solenoid valve 2210 are supplied with an oil pressure provided by the modulator valve (3) 2330 regulating the line pressure PL as a basic pressure.

The SLT linear solenoid valve 2200 and the SLS linear solenoid valve 2210 each generate control pressure in accordance with a current value that is determined by a duty signal sent from the ECU 900.

Of the control pressure (output pressure) of the SLT linear solenoid valve 2200 and the control pressure (output pressure) of the SLS linear solenoid valve 2210, the control pressure supplied to the primary regulator valve 2100 is selected by a control valve 2400.

When a spool of the control valve 2400 is in a state (I) (a state shown on the left side) in FIG. 3, the control pressure is supplied from the SLT linear solenoid valve 2200 to the primary regulator valve 2100. That is, the line pressure PL is controlled in accordance with the control pressure of the SLT linear solenoid valve 2200.

When the spool of the control valve 2400 is in a state (II) (a state shown on the right side) in FIG. 3, the control pressure is supplied from the SLS linear solenoid valve 2210 to the primary regulator valve 2100. That is, the line pressure PL is controlled in accordance with the control pressure of the SLS linear solenoid valve 2210.

In addition, when the spool of the control valve 2400 is in the state (II) in FIG. 3, the control pressure of the SLT linear solenoid valve 2200 is supplied to a manual valve 2600 described later.

The spool of the control valve 2400 is urged in one direction by a spring. In order to counteract this elastic force of the spring, oil pressure is supplied from a shift control-purpose duty solenoid (1) 2510 and a shift control-purpose duty solenoid (2) 2520.

When oil pressure is supplied from both the shift control-purpose duty solenoid (1) 2510 and the shift control-purpose duty solenoid (2) 2520 to the control valve 2400, the spool of the control valve 2400 is in the state (If) in FIG. 3.

When the oil pressure from at least one of the shift control-purpose duty solenoid (1) 2510 and the shift control-purpose duty solenoid (2) 2520 is not supplied to the control valve 2400, the spool of the control valve 2400 is in the state (I) in FIG. 3 due to the elastic force of the spring.

The shift control-purpose duty solenoid (1) 2510 and the shift control-purpose duty solenoid (2) 2520 are supplied with oil pressure regulated by the modulator valve (4) 2340. The modulator valve (4) 2340 regulates the oil pressure supplied from the modulator valve (3) 2330 to a constant pressure.

The modulator valve (1) 2310 outputs oil pressure provided by regulating the line pressure PL as a basic pressure. The oil pressure output from the modulator valve (1) 2310 is supplied to the hydraulic cylinder of the secondary pulley 508. The hydraulic cylinder of the secondary pulley 508 is supplied with such an oil pressure that the transmission belt 510 does not slip.

The modulator valve (1) 2310 is provided with a spool that moves in the directions of an axis, and a spring that urges the spool in one direction. The modulator valve (1) 2310 regulates the line pressure PL introduced into the modulator valve (1) 2310 by using as a pilot pressure the output pressure of the SLS linear solenoid valve 2210 that is duty-controlled by the ECU 900. The oil pressure regulated by the modulator valve (3) is supplied to the hydraulic cylinder of the secondary pulley 508. The belt clamping pressure is increased or decreased in accordance with the output pressure of the modulator valve (1) 2310.

The SLS linear solenoid valve 2210 is controlled to provide a belt clamping pressure that does not cause belt slippage, in accordance with a map in which the accelerator operation amount A(CC) and the gear ratio GR are used as parameters. Concretely, the exciting current to the SLS linear solenoid valve 2210 is controlled with a duty ratio that corresponds to the belt clamping pressure. In addition, if the transmission torque sharply changes at the time of acceleration or deceleration or the like, the belt clamping pressure may be corrected in the increasing direction to restrain the belt slippage.

The oil pressure supplied to the hydraulic cylinder of the secondary pulley 508 is detected by a pressure sensor 2312.

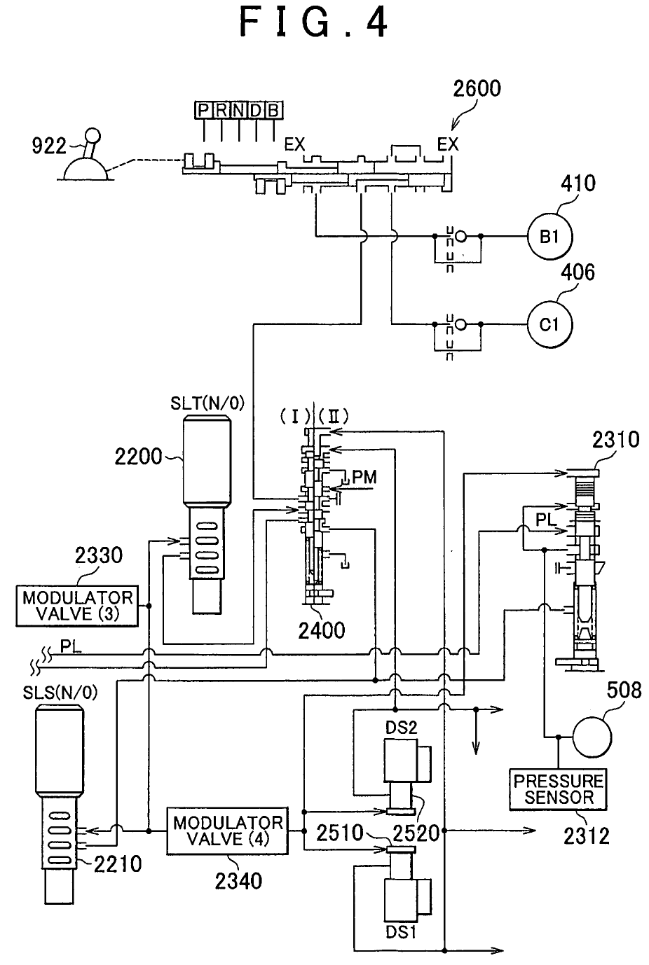

With reference to FIG. 4, the manual valve 2600 will be described. The manual valve 2600 is mechanically switched in accordance with the operation of the shift lever 922. Due to this, the forward clutch 406 and the reverse brake 410 may be engaged or released.

The shift lever 922 may be shifted between, for example, a “P” position for parking, an “R” position for reverse running, an “N” position of shutting off the power transmission, and a “D” position and a “B” position for forward running.

At the “P” position and the “N” position, the oil pressure in the forward clutch 406 and the reverse brake 410 is drained through the manual valve 2600. Due to this, the forward clutch 406 and the reverse brake 410 are released.

At the “R” position, oil pressure is supplied from the manual valve 2600 to the reverse brake 410. This engages the reverse brake 410. On the other hand, the oil pressure in the forward clutch 406 is drained through the manual valve 2600. This releases the forward clutch 406.

When the control valve 2400 is in a state (I) (a state shown on the left side) in FIG. 4, the modulator pressure PM from a modulator valve (2) (not shown) is supplied to the manual valve 2600 via the control valve 2400. The modulator pressure PM holds the reverse brake 410 in the engaged state.

When the control valve 2400 is in a state (II) (a state shown on the right side) in FIG. 4, the oil pressure regulated by the SLT linear solenoid valve 2200 is supplied to the manual valve 2600. By regulating the oil pressure via the SLT linear solenoid valve 2200, the reverse brake 410 is gently engaged to restrain shock at the time of engagement.

At the “D” position and the “B” position, oil pressure is supplied from the manual valve 2600 to the forward clutch 406. This engages the forward clutch 406. On the other hand, the oil pressure in the reverse brake 410 is drained through the manual valve 2600. This releases the reverse brake 410.

When the control valve 2400 is in the state (I) (the state shown on the left side) in FIG. 4, the modulator pressure PM from the modulator valve (2) (not shown) is supplied to the manual valve 2600 via the control valve 2400. The modulator pressure PM holds the forward clutch 406 in the engaged state.

When the control valve 2400 is in the state (I1) (the state shown on the right side) in FIG. 4, the oil pressure regulated by the SLT linear solenoid valve 2200 is supplied to the manual valve 2600. By regulating the oil pressure via the SLT linear solenoid valve 2200, the forward clutch 406 is gently engaged to restrain shock at the time of engagement.

Ordinarily, the SLT linear solenoid valve 2200 controls the line pressure PL via the control valve 2400. Ordinarily, the SLS linear solenoid valve 2210 controls the belt clamping pressure via the modulator valve (1) 2310.

However, if a neutral control execution condition, which includes a condition that the vehicle has stopped (the vehicle speed has become “0”) with the shift lever 922 being at the “D” position is met, the SLT linear solenoid valve 2200 controls the engagement force of the forward clutch 406 so that the engagement force of the forward clutch 406 declines. The SLS linear solenoid valve 2210 controls the belt clamping pressure via the modulator valve (1) 2310, and also controls the line pressure PL in substitute for the SLT linear solenoid valve 2200.

When a garage shift is performed in which the shift lever 922 is operated from the “N” position to the “D” position or the “R” position, the SLT linear solenoid valve 2200 controls the engagement force of the forward clutch 406 or the reverse brake 410 so that the forward clutch 406 or the reverse brake 410 gently engages. The SLS linear solenoid valve 2210 controls the belt clamping pressure via the modulator valve (1) 2310, and controls the line pressure PL in substitute for the SLT linear solenoid valve 2200.

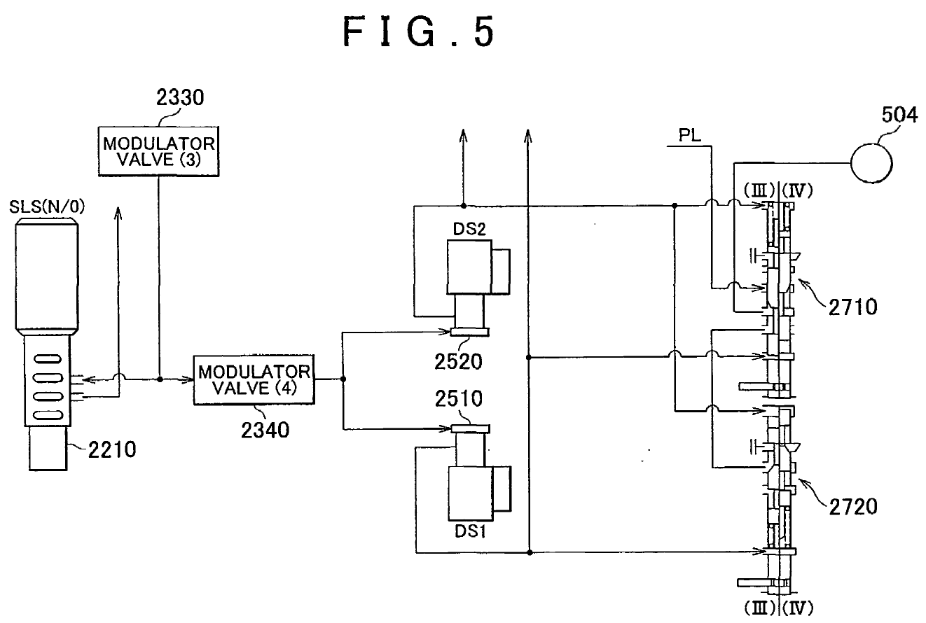

With reference to FIG. 5, a construction for performing the shift control will be described. The shift control is performed by controlling the supply and discharge of the oil pressure with respect to the hydraulic cylinder of the primary pulley 504. The supply and discharge of working oil with respect to the hydraulic cylinder of the primary pulley 504 is performed through the use of a ratio control valve (1) 2710 and a ratio control valve (2) 2720.

The ratio control valve (1) 2710 supplied with the line pressure PL, and the ratio control valve (2) 2720 connected to the drain are connected in communication with the hydraulic cylinder of the primary pulley 504.

The ratio control valve (1) 2710 is a valve for executing upshift. The ratio control valve (1) 2710 is constructed so that a channel between an input port that is supplied with the line pressure PL and an output port connected in communication with the hydraulic cylinder of the primary pulley 504 is opened and closed by a spool.

A spring is disposed on an end portion of the spool in the ratio control valve (1) 2710. A port that is supplied with the control pressure from the shift control-purpose duty solenoid (1) 25 10 is formed in an end portion remote from the spring disposed on the end portion of the spool. Aport that is supplied with the control pressure from the shift control-purpose duty solenoid (2) 2520 is formed in an end portion at the side where the spring is disposed.

When the control pressure from the shift control-purpose duty solenoid (1) 2510 is increased and the output of the control pressure from the shift control-purpose duty solenoid (2) 2520 is interrupted, the spool of the ratio control valve (1) 2710 assumes a state (IV) (a state shown on the right side) in FIG. 5.

In this state, the oil pressure supplied to the hydraulic cylinder of the primary pulley 504 increases, so that the groove width of the primary pulley 504 narrows. Therefore, the gear ratio decreases. That is, an upshift occurs. Besides, by increasing the supply flow rate of working oil at that time, the shifting speed is increased.

The ratio control valve (2) 2720 is a valve for executing downshift. A spring is disposed on an end portion of the ratio control valve (2) 2720. A port that is supplied with the control pressure from the shift control-purpose duty solenoid (1) 2510 is formed in an end portion at the side where the spring is disposed. A port that is supplied with the control pressure from the shift control-purpose duty solenoid (2) 2520 is formed in an end portion remote from the spring disposed on the end portion of the spool.

When the control pressure from the shift control-purpose duty solenoid (2) 2520 is increased and the output of control pressure from the shift control-purpose duty solenoid (1) 2510 is interrupted, the spool of the ratio control valve (2) 2720 assumes a state (III) (a state shown on the left side) in FIG. 5. Simultaneously, the spool of the ratio control valve (I) 2710 assumes a state (III) (a state shown on the left side) in FIG. 5.

In this state, the working oil is discharged from the hydraulic cylinder of the primary pulley 504 via the ratio control valve (1) 2710 and the ratio control valve (2) 2720. Therefore, the groove width of the primary pulley 504 widens. Consequently, the gear ratio increases. That is, a downshift occurs. Besides, by increasing the discharge flow rate of working oil, the shifting speed becomes faster.

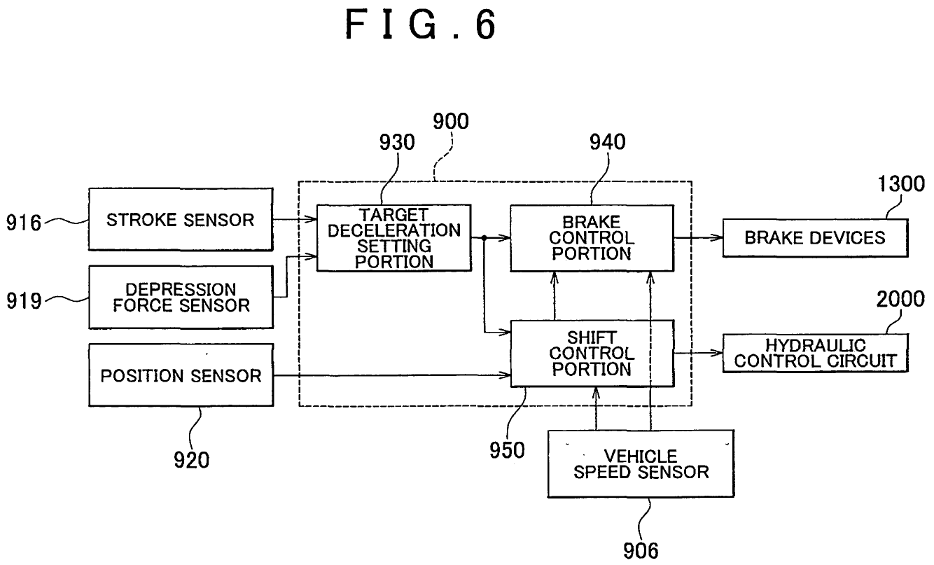

With reference to FIG. 6, the ECU 900 will be further described. The ECU 900 includes a target-deceleration setting portion 930, a brake control portion 940, and a shift control portion 950.

The target-deceleration setting portion 930 sets a target deceleration of the vehicle on the basis of at least one of the amount of operation of the brake pedal 918 detected by the stroke sensor 916 and the depression force of the brake pedal 918 detected by the depression force sensor 919. The target deceleration is set, for example, in accordance with a map created beforehand through the use of the amount of operation of the brake pedal 918 or the depression force thereof as a parameter. The greater the amount of operation or the depression force of the brake pedal 918, the smaller the target deceleration is set. Incidentally, in this embodiment, the deceleration is expressed as a negative value. The smaller the deceleration, the greater the braking force.

The brake control portion 940 controls the brake devices 1300 on the basis of the target deceleration. When the vehicle is decelerated by the brake devices 1300, the brake devices 1300 are controlled to generate a braking force that realizes the target deceleration. In this case, the brake devices 1300 are controlled in accordance with a map created beforehand through the use of the deceleration as a parameter.

The shift control portion 950, on the basis of the vehicle speed, sets such a gear ratio that the braking force from the powertrain, that is, the deceleration caused by engine braking, becomes equal to the target deceleration. The belt type stepless transmission 500 is controlled via the hydraulic control circuit 2000 to achieve that gear ratio. The gear ratio is calculated from a map created beforehand through the use of the vehicle speed and the deceleration as parameters. The calculation is made so that the smaller the target deceleration (the greater the braking force), the greater the gear ratio becomes.

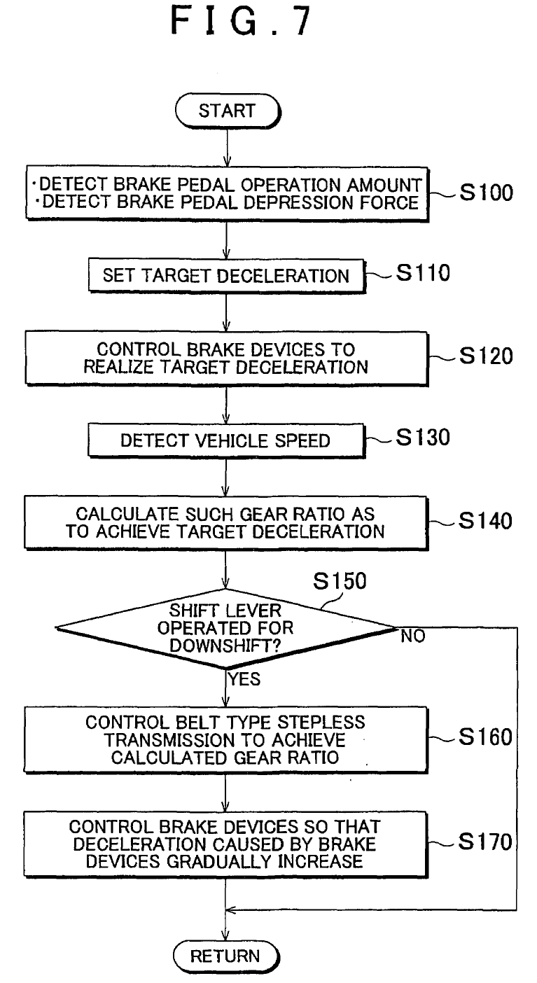

With reference to FIG. 7, a control structure of a program executed by the ECU 900 of the control device in accordance with this embodiment will be described. The program described below is periodically executed at predetermined intervals.

In step (hereinafter, step is abbreviated to S) 100, the ECU 900 detects the amount of operation of the brake pedal 918 on the basis of the signal sent from the stroke sensor 916, and detects the depression force of the brake pedal 918 on the basis of the signal sent from the depression force sensor 919.

In S110, the ECU 900 sets a target deceleration of the operation vehicle on the basis of at least one of the amount of operation and the depression force of the brake pedal 918.

In S120, the ECU 900 controls the brake devices 1300 so that the deceleration caused by the braking force from the brake devices 1300 becomes equal to the target deceleration.

In S130, the ECU 900 detects the vehicle speed on the basis of the signal sent from the vehicle speed sensor 906. In S140, the ECU 900, on the basis of the vehicle speed, sets a gear ratio where the braking force from the powertrain, that is, the deceleration caused by engine braking, becomes equal to the target deceleration.

In S150, the ECU 900 determines whether the shift lever 922 has been operated to downshift the belt type stepless transmission 500. If the shift lever 922 has been operated to downshift the belt type stepless transmission 500 (YES in S150), the process proceeds to S160. If not (NO in S150), this process ends.

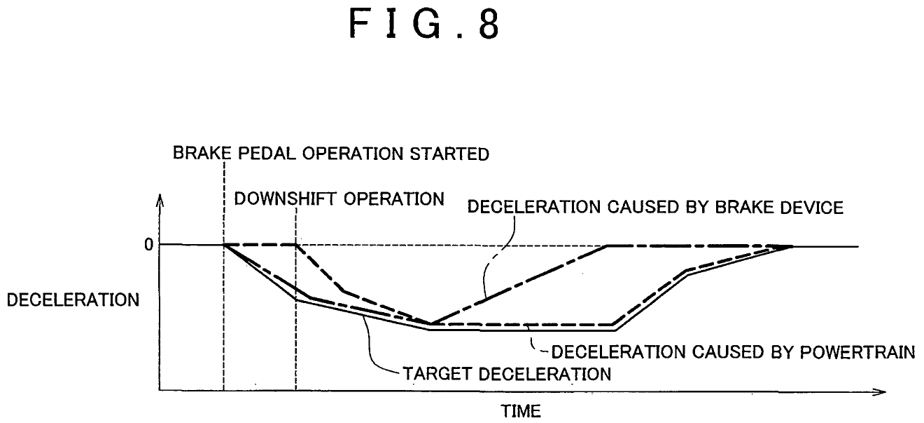

In S160, the ECU 900 controls the belt type stepless transmission 500 so that the gear ratio calculated in S140 is achieved. In S170, the ECU 900 controls the brake devices 1300 so that the deceleration caused by the brake devices 1300 gradually increases (i.e., so that the braking force gradually decreases). As shown in FIG. 8, at the timing when the braking force from the powertrain 100, that is, the deceleration caused by engine braking, reaches the target deceleration, the deceleration caused by the brake devices 1300 is gradually increased.

The operation of the ECU 900, which is the control device in accordance with the embodiment, on the basis of the structure and the flow of control described above, will be described.

When the vehicle is moving, the amount of operation of the brake pedal 918 is detected on the basis of the signal sent from the stroke sensor 916, and the depression force of the brake pedal 918 is detected on the basis of the signal sent from the depression force sensor 919 (S100). A target deceleration in accordance with at least one of the detected amount of operation and the detected depression force of the brake pedal 918 is set (S110). The brake devices 1300 are controlled so that the deceleration caused by the braking force from the brake devices 1300 becomes equal to the target deceleration (S120).

Furthermore, the vehicle speed is detected on the basis of the signal sent from the vehicle speed sensor 906 (S130), and a gear ratio where the braking force from the powertrain, that is, the deceleration caused by engine braking, becomes equal to the target deceleration is calculated on the basis of the vehicle speed (S140).

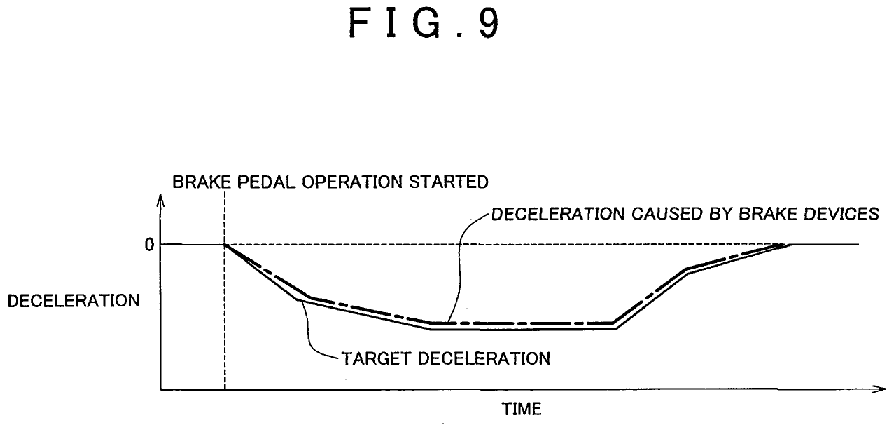

If during the deceleration, the driver does not operate the shift lever 922 (NO in S150) and only operates the brake pedal 918, the target deceleration is realized by the brake devices 1300 as shown in FIG. 9.

On the other hand, if during the deceleration of the vehicle, the driver operates the shift lever 922 (YES in S150) to downshift the belt type stepless transmission 500 and therefore apply engine braking, the belt type stepless transmission 500 is controlled to achieve a gear ratio where the target deceleration is realized by the braking force from the powertrain (S160).

Furthermore, as shown in FIG. 8, when the deceleration caused by the powertrain reaches the target deceleration, the deceleration caused by the brake devices 1300 is gradually increased (S170). Therefore, when a downshift is performed, the vehicle can be decelerated at a deceleration that the occupant needs.

According to the ECU that is the control device in accordance with the embodiment, the target deceleration is set on the basis of at least one of the amount of operation of the brake pedal and the depression force thereof. The brake devices are controlled so that the deceleration caused by the brake devices becomes equal to the set target deceleration. If during the deceleration using the brake devices, the shift lever is operated to downshift the belt type stepless transmission, the belt type stepless transmission is controlled so that the deceleration caused by the powertrain becomes equal to the target deceleration. When the deceleration caused by the powertrain reaches the target deceleration, the deceleration caused by the brake devices is gradually increased. Therefore, if a downshift is performed, the vehicle is decelerated at a deceleration rate desired by the occupant.

Although in the embodiment, the target deceleration is set in accordance with at least one of the amount of operation and the depression force of the brake pedal 918, it is also possible to set a braking force in substitute for the target deceleration.

It is to be understood that the embodiments disclosed in this application are not restrictive but illustrative in all respects. The scope of the invention is shown not by the foregoing description but by the claims for patent, and is intended to cover all modifications within the meaning and scope equivalent to the claims for patent.

What is claimed is:

1. A control device for a vehicle that includes
a braking mechanism that restrains rotation of a wheel by using friction force; and
a powertrain that transmits drive force from a power source to the wheel via a transmission,
the control device comprising:
a setting device for setting a physical amount that represents a rate of deceleration of the vehicle, in accordance with an operation performed on a first operating member;
a first control portion for controlling the braking mechanism so that the rate of deceleration of the vehicle caused by braking force from the braking mechanism becomes substantially equal to the rate of deceleration that corresponds to the set physical amount;
a calculation device for calculating an appropriate gear ratio where the rate of deceleration of the vehicle caused by the braking force from the powertrain becomes substantially equal to the rate of deceleration that corresponds to the set physical amount;
a second control portion for controlling the transmission to achieve the calculated gear ratio if the second operating member is operated during the deceleration of the vehicle caused by the braking mechanism; and,
a third control portion for controlling the braking mechanism to decrease the braking force caused by the braking mechanism if the braking force from the powertrain is increased by controlling the transmission during execution of the second control.

2. The control device for the vehicle according to claim 1, wherein
the first operating member is a brake pedal, and the second operating member is a shift lever.

3. The control device for the vehicle according to claim 1, wherein
the automatic transmission is a stepless transmission.

4. A control method for a vehicle comprising:
setting a physical amount that represents a rate of deceleration of the vehicle, in accordance with an operation of a first operating member;
performing a first control on a braking mechanism, which restrains rotation of a wheel by using friction force, so that the rate of deceleration of the vehicle caused by braking force from the braking mechanism becomes substantially equal to the rate of deceleration that corresponds to the set physical amount;
calculating a gear ratio where the rate of deceleration of the vehicle caused by the braking force from a powertrain that transmits drive force from a power source to the wheel via a transmission becomes substantially equal to the rate of deceleration that corresponds to the set physical amount;
performing a second control on the transmission to achieve the calculated gear ratio if a second operating member is operated during the deceleration of the vehicle caused by the braking mechanism; and
performing a third control on the braking mechanism to decrease the braking force caused by the braking mechanism if the braking force from the powertrain is increased through the control of the transmission performed in the second control.

5. The control method for the vehicle according to claim 4, wherein
the first operating member is a brake pedal, and the second operating member is a shift lever.
